(19) United States
(12) Patent Application Publication
(10) Pub. No.: US 2023/0189866 A1
(43) Pub. Date: Jun. 22, 2023

(54) CITRUS FRUIT MANUFACTURING METHOD AND CITRUS FRUIT

(71) Applicant: Kosui Fukaya, Ibaraki (JP)

(72) Inventor: Kosui Fukaya, Ibaraki (JP)

(21) Appl. No.: 17/927,809

(22) PCT Filed: May 28, 2021
(86) PCT No.: PCT/JP2021/020400

§ 371 Date: Nov. 25, 2022

(30) Foreign Application Priority Data
May 28, 2020 (JP) 2020-092985

(51) Int. Cl. A23N 7/01

(52) U.S. Cl. CPC A23N 7/01

(57) ABSTRACT

A citrus fruit manufacturing method includes a pretreatment step of partly removing an outer skin of a citrus fruit and/or making a cut into the outer skin, an enzyme solution impregnation step of immersing the pretreated citrus fruit into an enzyme solution which can decompose the outer skin and is temperature adjusted to normal temperature or 10° C. to 40° C., in a decompression space, an outer skin decomposition and removal step of decomposing and removing the outer skin from the impregnated citrus fruit in the enzyme solution, a finishing process step of washing with water the decomposed and removed citrus fruit of the outer skin, and an inner skin decomposition and removal step of separating the spherical citrus fruit washed with water and peeled off only the outer skin into juice vesicles with an inner skin to immerse into the enzyme solution and decomposing and removing the inner skin.

### TECHNICAL FIELD

The present invention relates to a skin peeling technique for citrus fruits.

### BACKGROUND ART

People like citrus fruits such as tangerines and oranges, but in recent years citrus fruits tend to be avoided because peeling them is difficult and they do not feel like eating them.

Then, there has been developed an inner skin removing technique for peeling not only an outer skin, but also an inner skin covering a fruit pulp (juice vesicles) of the citrus fruit and allowing the fruit pulp of the citrus fruit to be eaten as it is (patent literature 1).

### CITATION LIST

### Patent Literature

Patent Literature 1: Japanese Unexamined Patent Publication No. 2014-54246

### SUMMARY OF INVENTION

### Technical Problem

The inventor of the present invention has devoted efforts to the tests and research for the purpose of providing a citrus fruit composed only of a fruit pulp (juice vesicles) in which an outer skin and an inner skin are securely peeled off by a different method from the conventionally developed citrus fruit skin peeling technique, and has come to complete the present invention.

### Solution to Problem

A first aspect of the present invention is a citrus fruit manufacturing method including a pretreatment step of partly removing an outer skin of a citrus fruit and/or making a cut into the outer skin, an enzyme solution impregnation step of immersing the pretreated citrus fruit into an enzyme solution which can decompose the outer skin and is temperature adjusted to normal temperature or 10° C. to 40° C., in a decompression space, an outer skin decomposition and removal step of decomposing and removing the outer skin from the impregnated citrus fruit in the enzyme solution, a finishing process step of washing with water the decomposed and removed citrus fruit of the outer skin, and an inner skin decomposition and removal step of separating the spherical citrus fruit which is washed with water and is peeled off only the outer skin into bunches (juice vesicles) with an inner skin (citrus fruit segment) to immerse into the enzyme solution and decomposing and removing the inner skin, thereby producing the citrus fruit composed only of the juice vesicles in which the outer skin and the inner skin are peeled off.

A second aspect of the present invention is the citrus fruits manufacturing method characterized in that a cellulase-base enzyme is contained in the enzyme solution.

A third aspect of the present invention is the citrus fruits manufacturing method characterized in that an enzyme concentration of the enzyme solution in the inner skin decomposition and removal step is between 0.03 and 0.1%.

A fourth aspect of the present invention is the citrus fruits manufacturing method characterized in that a temperature zone of the enzyme solution in the inner skin decomposition and removal step is normal temperature or between 10° C. and 40° C.

A fifth aspect of the present invention is the citrus fruit production method characterized in that a time zone of the enzyme solution in the inner skin decomposition and removal step is less than 10 hours.

A sixth aspect of the present invention is a citrus fruit composed only of juice vesicles which are produced by the citrus fruit production method according to the first aspect to the fifth aspect.

### Effect of Invention

According to the present invention mentioned above, the following effects can be obtained.

It is possible to provide the citrus fruit composed only of the juice vesicles in which the outer skin and the inner skin are securely peeled off.

It is possible to provide the citrus fruit composed only of the juice vesicles in which the outer skin and the inner skin are peeled off without spoiling its freshness.

### BRIEF DESCRIPTION OF DRAWINGS

FIG. 1 is an explanatory view describing an outer skin decomposition and removal step.

FIG. 2 is an explanatory view describing a finishing process step.

FIG. 3 is an explanatory view describing an inner skin decomposition and removal step.

### DESCRIPTION OF EMBODIMENT

A description will be given of an embodiment according to the present invention with reference to the accompanying drawings. Contents of steps described below are provided only for exemplifying and the present invention is not limited to them.

A citrus fruit production method composed only of juice vesicles according to the present invention includes the following steps.
(A) pretreatment step
(B) enzyme solution impregnation step
(C) outer skin decomposition and removal step
(D) finishing process step
(E) inner skin decomposition and removal step

In the “pretreatment step” (A), an outer skin of citrus fruit are partly removed and/or cut. For example, the outer skin at the top end portion and/or the bottom end portion of the citrus fruits are cut, or make cuts into the outer skin in a direction of a horizontal axis and/or a direction of a vertical axis.

In the “enzyme solution impregnation step” (B), the pretreated citrus fruits are immersed in an enzyme solution at normal temperature or in a temperature range of 10° C. to 40° C.

Here, a “cellulase-base” enzyme is employed as the enzyme solution. An enzyme concentration is between 0.03 and 0.1 %.

Further, this step is performed for once or twice, and each time is between 1 minute and 5 minutes.

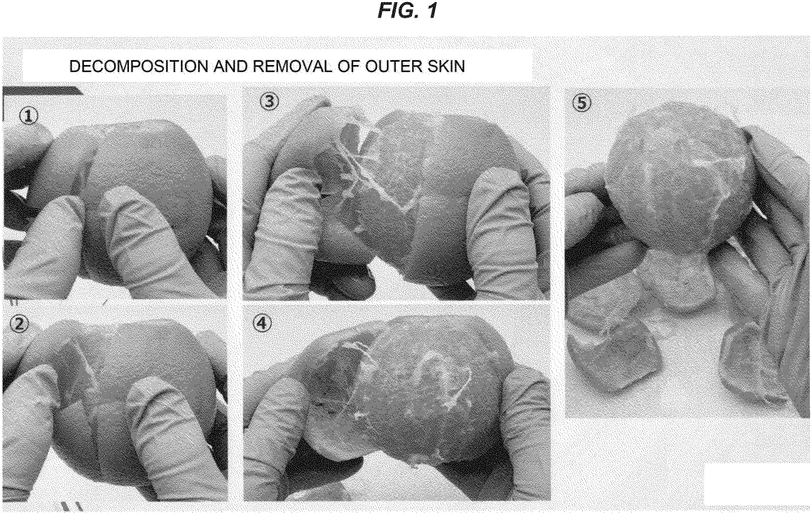

FIG. 1 is an explanatory view describing the “outer skin decomposition and removal step” of (C). The step decomposes and removes the outer skin from the citrus fruits impregnated in the enzyme solution. At this time, the outer skin is not completely peeled off. A flavedo (exocarp) positioned at inside and outside in the outer skin is removed. However, an albedo (an endocarp) positioned in an inner side is not completely removed, but remains as illustrated in number 5 of FIG. 1. However, the albedo is intentionally left here.

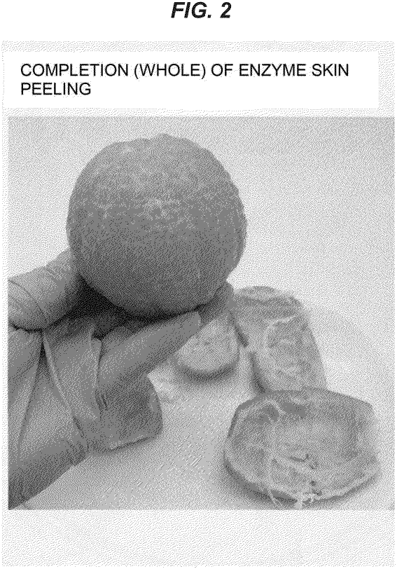

FIG. 2 is an explanatory view describing the “finishing process step” of (D). The step washes with water the citrus fruits in which the outer skin is decomposed and removed. The enzyme is washed away with water, the albedo is removed and a part of a fruit bag (an inner skin) contacting with the albedo is left. A loss of shape in the bunches (the juice vesicles) can be prevented in the next performed inner skin decomposition and removal step by intentionally leaving the fruit bag (the inner skin or also called as a citrus fruit segment “jonou”.

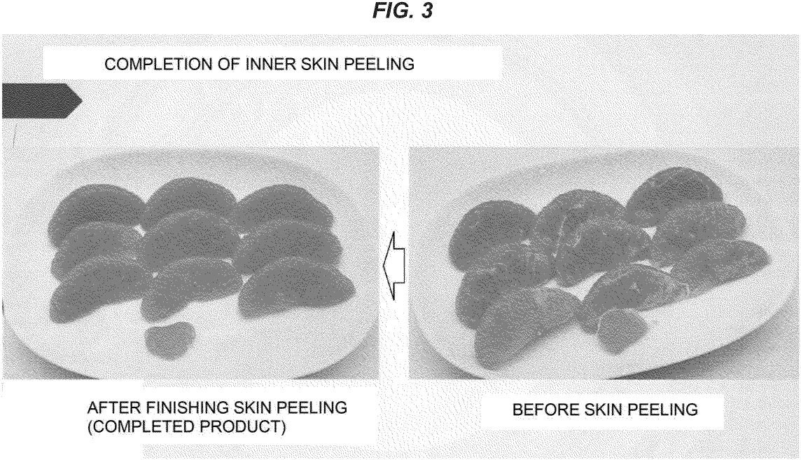

FIG. 3 is an explanatory view describing the “inner skin decomposition and removal step” of (E).

Spherical citrus fruits washed with water and peeled off only the outer skin are divided into the juice vesicles with the inner skin to immerse into the enzyme solution, and decomposes and removes the fruit bag (the inner skin) covering the juice vesicles.

Here, the same “cellulase-base” enzyme as that used when decomposing the outer skin is employed as the enzyme solution. The enzyme concentration is between 0.03 and 0.1 %.

Further, a temperature zone of the enzyme solution is normal temperature or between 10° C. and 40° C.

Further, a time zone for immersing in the enzyme solution is less than 10 hours.

As described above, it is possible to provide the citrus fruits in a bunchy state composed only of the fruit pulp in which the outer skin and the inner skin are peeled off, as illustrated in FIG. 3. Further, in spite of the fact that the fruit bag (the inner skin) is peeled off, a drip is not generated and a fresh fruit pulp with rich freshness and without any loss of shape can be provided.

### INDUSTRIAL APPLICABILITY

The present invention can be widely utilized for citrus fruits having outer and inner skins.

1. A citrus fruit manufacturing method comprising:
a pretreatment step of partly removing an outer skin of a citrus fruit and/or making a cut into the outer skin;
an enzyme solution impregnation step of immersing the pretreated citrus fruits into an enzyme solution which can decompose the outer skin and is temperature adjusted to normal temperature or 10° C. to 40° C., in a decompression space; an outer skin decomposition and removal step of decomposing and removing the outer skin from the impregnated citrus fruit in the enzyme solution;
a finishing process step of washing with water the decomposed and removed citrus fruit of the outer skin; and
an inner skin decomposition and removal step of separating the spherical citrus fruit which is washed with water and is peeled off only the outer skin into juice vesicles with an inner skin to immerse into the enzyme solution and decomposing and removing the inner skin,
wherein in the outer skin decomposition and removal step, a flavedo (exocarp) positioned at inside and outside in the outer skin is removed, and an albedo (an endocarp) positioned in an inner side is not completely removed, but remains and is removed in the finishing process step, so that the citrus fruit composed only of the juice vesicles in which a drip is not generated, any loss of shape is not provided, and the outer skin and the inner skin are peeled off.

2. The citrus fruit production method according to claim 1, wherein a cellulase-base enzyme is contained in the enzyme solution.

3. (canceled)

4. (canceled)

5. (canceled)

6. A citrus fruit composed only of the juice vesicles which are produced by the citrus fruit production method according to claim 1.

7. Acitrus fruit composed only of the juice vesicles which are produced by the citrus fruit production method according to claim 2.
